(19) United States
(12) Patent Application Publication
(10) Pub. No.: US 2010/0208340 A1
(43) Pub. Date: Aug. 19, 2010

(54) OBSERVATION DEVICE

(75) Inventor: Yasujiro Kiyota, Tokyo (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/682,018

(22) PCT Filed: Oct. 10, 2008
(86) PCT No.: PCT/JP2008/068483

§ 371 Date: Apr. 7, 2010

(30) Foreign Application Priority Data
Oct. 11, 2007 (JP) 2007-265142

(51) Int. Cl. G02B 21/06

(52) U.S. Cl. 359/385

(57) ABSTRACT

An observation device that limits the brightness of an area to be a background of a sample, so that contrast of the sample can be clearly observed in the reflection observation method. An illumination light quantity limiting stop that is disposed on the emission-side pupil surface of the illumination light has a doughnut shape, by which an opening portion is formed at the center of a disk, so that the peripheral portion of the luminous flux of the illumination light is interrupted and only the center portion thereof is transmitted. An incident light quantity limiting stop that is disposed on the incident-side pupil surface has a circular shape smaller than the cross-section of the luminous flux, so that the center portion of the luminous flux is interrupted, and therefore only the peripheral portion of the luminous flux of the reflected light is transmitted.

### TECHNICAL FIELD

The present invention relates to an observation device, and more particularly to an observation device that can be appropriately used when reflected light of the illumination light irradiated onto a sample is observed.

### BACKGROUND ART

To observe a micro bio-sample, such as a cell, a transmission method using a phase contrast microscope or a differential interference microscope is conventionally used. In this transmission observation method, the illumination light is irradiated onto a sample, and transmitted light thereof is observed.

In some cases a bio-sample is standing still in a relatively small incubator (individual well), such as a 96 well plate. With this small incubator, however, a meniscus effect is generated, that is the culture medium (e.g. water) rises above the wall face of the incubator due to surface tension, and generates a lens function, which causes an optical error.

Therefore if a bio-sample standing still in a relatively small incubator is observed by a transmission observation method, the optical performance is influenced by the meniscus effect, and an accurate image forming state cannot be observed.

Possible methods to solve this problem is a method for installing a lens system for cancelling the meniscus effect (e.g. Patent Document 1), and a fluorescence observation method, which irradiates illumination light onto a sample using an inverted microscope, observing fluorescence thereof.

[Patent Document 1] Japanese Patent Application Laid-Open No. H8-5929

If the fluorescence observation method is used, the sample is labeled using fluorescent die, whereby the observation result, in which contrast of the sample is enhanced, can be obtained.

However influence of the fluorescent die on the organism of the bio-sample cannot be ignored, so it is preferable not to use fluorescent die.

Reflection of the illumination light, on the other hand, is generated on the interface between materials having a different refractive index, and the reflection angle thereof depends on the angle of this interface. The reflection efficiency of a regular reflection depends on the refractive index difference in the interface.

The refractive index of each material related to the observation of a bio-sample is as follows.

| Incubator (polystyrene) | 1.59 to 1.60 |
|---|---|
| Culture medium (water, 20° C.) | 1.33 |
| Bio-sample (cytoplasm) | 1.35 to 1.38 |
| Bio-sample (cell nucleus) | 1.39 |
| Bio-sample (mitochondria) | 1.40 to 1.42 |
| Bio-sample (cell membrane) | 1.46 |
| Bio-sample (lipid) | 1.48 |
| Bio-sample (protein) | 1.50 to 1.58 |
| Bio-sample (melanin) | 1.7 |

Therefore in the bottom face of the incubator that is observed by the reflection observation method, an interface in which refractive index difference is highest, that is an interface of which reflection efficiency is highest, is the interface between the incubator (1.59) and the culture medium (1.33).

Since the reflection efficiency is highest in the interface between the incubator and the culture medium is highest, if the bottom face of the incubator is observed, the area to be a background of the bio-sample (interface between the incubator and the culture medium), out of the bottom face, becomes too bright in the image to be observed, and as a result, the contrast between the bio-sample and the culture medium becomes obscure, which makes it difficult to observe the bio-sample clearly.

### DISCLOSURE OF THE INVENTION

With the foregoing in view, it is an object of the present invention to allow observing the contrast of the sample clearly in the reflection observation method, by not letting the reflected light be observed in the area to be a background of the sample.

An observation device of the present invention is an observation device that irradiates illumination light onto a sample standing sill in a container from the bottom face side of the container so as to observe the reflected light of the illumination light, the device comprising: illumination light quantity limiting means for interrupting the peripheral side of the luminous flux cross-section of the illumination light and transmitting the center side thereof; irradiation control means for irradiating the illumination light that is limited by the illumination light quantity limiting means onto the sample standing still in the container from the bottom face side of the container; and incident light quantity limiting means for interrupting the center side of the luminous flux cross-section of the reflected light of the illumination light irradiated from the bottom face side of the container and transmitting the peripheral side thereof.

It is possible that the illumination light quantity limiting means is disposed on the emission side pupil surface of the illumination light, and the incident light quantity limiting means is disposed on the incident side pupil surface of the reflected light.

It is possible that the illumination light quantity has an opening portion for transmitting the center side of the illumination light, the incident light quantity limiting means has an interruption portion for interrupting the center side of the reflected light, and a size of at least one of the opening portion or the interruption portion is variable.

The observation device of the present invention may further comprise imaging means for generating image data based on the reflected light limited by the incident light quantity limiting means.

According to the present invention, the brightness of the area to be the background of the sample can be limited in the reflection observation method. Therefore the contrast of the sample can be clearly observed.

### BRIEF DESCRIPTION OF THE DRAWINGS

FIG. 1 is a diagram depicting a configuration example around an objective optical system in an inverted microscope according to the present invention;

FIG. 2 is a cross-sectional view of a bio-sample, to be observed, and an incubator;

FIG. 3 is a diagram depicting a relationship between an inclination of the interface and the traveling path of the reflected light; and

FIG. 4 is an image that is observed by the inverted microscope according to the present invention.

### EXPLANATION OF REFERENCE NUMERALS

11 illumination light quantity limiting stop
12 half mirror
13 objective optical system
14 incident light quantity limiting stop
21 bio-sample
22 incubator
23 culture medium

### BEST MODE FOR CARRYING OUT THE INVENTION

Embodiments of the present invention will now be described with reference to the drawings.

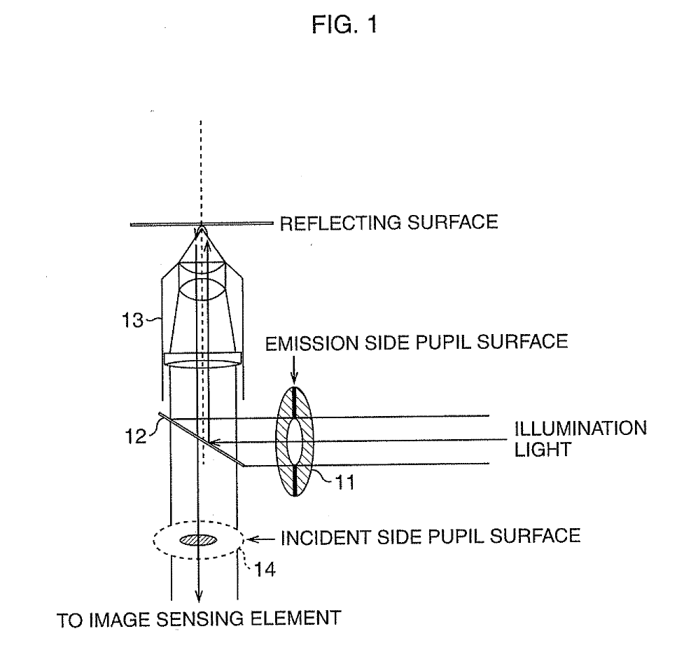

FIG. 1 shows a configuration example around an objective optical system of an inverted microscope according to an embodiment of the present invention.

A light source, that is not illustrated, is an LED having emission wavelength λ=460 to 490 nm.

In the inverted microscope, an illumination light quantity limiting stop 11, that is disposed on an emission side pupil surface of an illumination light, is formed in a doughnut shape having an opening portion at the center of a disk, so that the peripheral portion of the luminous flux of the illumination light is interrupted, and only the center portion is transmitted. As a result, the quantity of the illumination light can be limited by the illumination light quantity limiting stop 11.

The illumination light that transmitted through the illumination light quantity limiting stop 11 is reflected by a half mirror 12, and enters the objective optical system 13. The objective optical system 13 condenses the illumination light from the half mirror 12 onto a sample surface (reflecting surface). The objective optical system 13 also shapes the illumination light reflected by the sample surface (reflecting surface) (hereafter called “reflected light”) to be parallel. The reflected light from the objective optical system 13 transmits through the half mirror 12.

The incident light quantity limiting stop 14, that is disposed on the pupil surface at the incident side, has a circular shape smaller than the cross-section of the luminous flux, so that the center portion of the luminous flux is interrupted, which is opposite of the illumination light quantity limiting stop 11, and therefore transmits only the peripheral portion of the luminous flux of the reflected light.

The reflected light that passed through the incident light quantity limiting stop 14 enters onto an image sensing element, such as a CCD, and forms an image, and image data generated by the image sensing element is acquired as the observation result.

The size of the opening portion of the illumination light quantity limiting stop 11 and the size of the incident light quantity limiting stop 14 may be variable, so that the size of these stops can be interlocked and adjusted according to operation by the user.

The irradiation area by the illumination light is determined by the size of the opening portion of the illumination light quantity limiting stop 11, so the size of the opening portion of the illumination light quantity limiting stop 11 may be changed according to the size of the incubator in which the bio-sample is standing still.

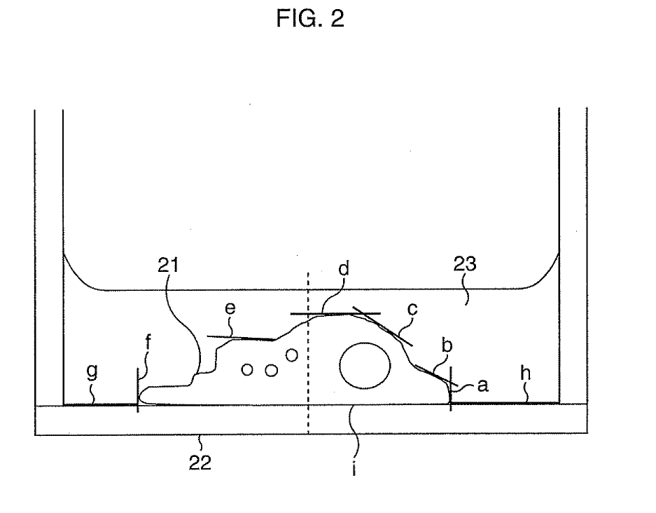

A bio-sample to be observed by the inverted microscope will now be described with reference to FIG. 2. A sample other than an organism can also be observed by this inverted microscope.

The bio-sample 21 is standing still in the incubator 22 containing a culture medium (e.g. water) 23, and is disposed on the observation target surface of the inverted microscope.

Here it is assumed that interfaces a, b, c, d, e and f shown in this figure are the interfaces between the bio-sample 21 and the culture medium 23. It is assumed that interfaces g and h shown in the same figure are the interfaces between the incubator 22 and the culture medium 23. And it is assumed that interface i in the figure is an interface between the bio-sample 21 and the incubator 22.

In the same, if the reference (0) of the inclination of the horizontal direction is the bottom face of the incubator 22, the inclinations of interfaces g, h and i are also 0, and the inclinations of the interfaces e and d are also approximately 0. The inclinations of the other interfaces a, b, c and f have angles greater than 0. These inclinations determine the reflection angle of the illumination light on each interface.

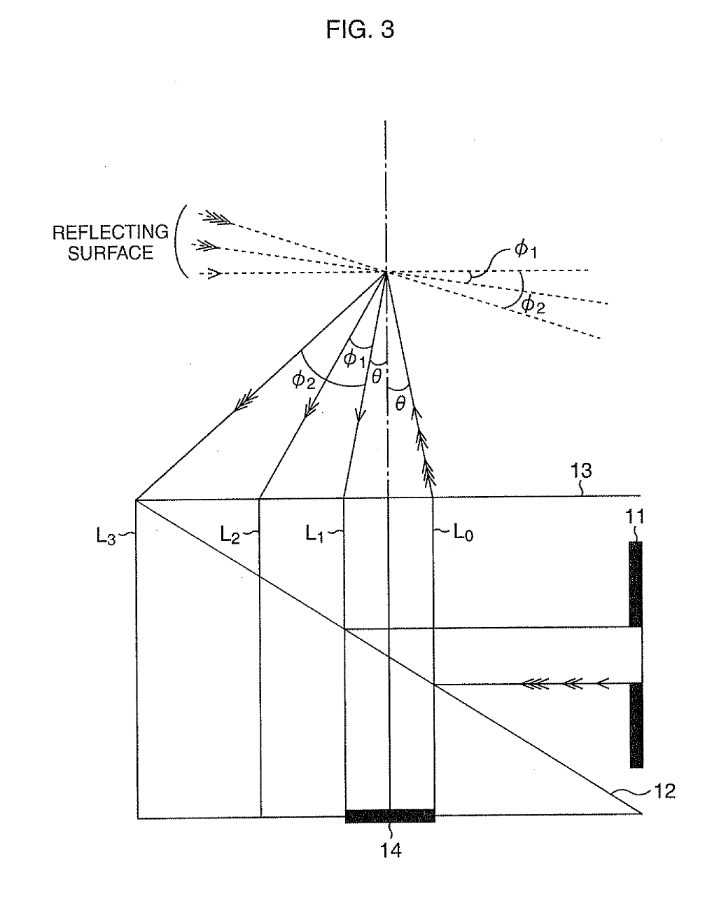

The relationship between the inclination of each interface and the traveling path of the reflected light will be described with reference to FIG. 3.

In FIG. 3, the light L₀ of the illumination light that transmitted through the illumination light quantity limiting stop 11 is described as an example. The light L₀ is reflected by the half mirror 12 to the objective optical system 13 side. In the objective optical system 13, the light L₀ is condensed onto the reflecting surface (each interface a to h shown in FIG. 2) at incident angle θ with respect to the optical axis of the illumination light.

If the inclination of the reflecting surface is 0 like the case of interfaces g, h and i in FIG. 2, the reflected light of the light L₀ becomes light L₁, of which inclination from the optical axis of the illumination light is θ. If the inclination of the reflecting surface is φ₁, the reflected light of light L₀ becomes light L₂, of which inclination from the optical axis of the illumination light is (θ+φ₁). If the inclination of the reflecting surface is φ₂, the reflected light of the light L₀ becomes light L₃, of which inclination from the optical axis of the illumination light is (θ+φ₂).

As FIG. 3 shows, the reflected light of the light L₀ has a smaller inclination from the optical axis as the inclination of the reflecting surface is close to 0. In other words, the light L₀, which is reflected by a reflecting surface of which inclination is close to 0, such as interfaces d, e, g, h and i in FIG. 2, is condensed to the center of the luminous flux of the reflected light.

Therefore by disposing the incident light quantity limiting stop 14 on the incident side pupil surface, as in the case of the inverted microscope according to the present invention, the light reflected by a reflecting surface of which inclination is close to 0, such as interfaces d, e, g, h and i in FIG. 2, can be interrupted.

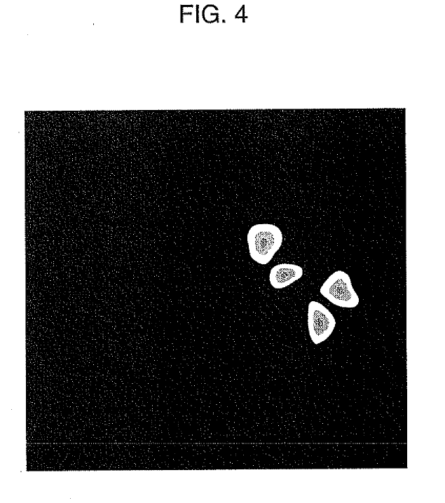

Therefore in the image to be observed, interfaces g, h and i (area to be a background of the bio-sample 21) becoming bright can be suppressed, as shown in FIG. 4. As a result, the contrast in the interface of which inclination is not close to 0 (e.g. interfaces a, b, c and f in FIG. 2) becomes clear among the interfaces between the bio-sample 21 and the culture medium 23.

The observed image in FIG. 4 is a model diagram acquired using an objective lens of which NA of 0.13, magnification of 4×, the aperture diameter of the illumination light quantity limiting stop 11 of 10 mm, and the diameter of the incident light quantity limiting stop 14 of 10 mm.

As mentioned above, if the size of the opening portion of the illumination light quantity limiting stop 11 and the size of the incident light quantity limiting stop 14 are designed to be variable, the user can adjust the sizes of the stops interlockingly, so that the contrast of the bio-sample 21 becomes clear enough to be easily observed while watching the image to be observed.

The present invention can be applied to a fluorescent block cassette holder used for fluorescence observation, in addition to the above mentioned embodiment.

The present invention can be applied not only to an inverted microscope, but also to a case of irradiating the illumination light onto a sample from the bottom face side, and observing the reflected light thereof.

The present embodiment is not limited to the above embodiments, but can be modified in various ways within a scope of not deviating from the spirit of the present invention.

1. An observation device comprising:
an illumination optical system that irradiates illumination lights onto a sample that stands still on a bottom face of a container in which a medium is injected, from the bottom face side of the container; and
an observation optical system that forms an image of reflected lights generated by the illumination lights irradiated from the bottom face side of the container, wherein
the observation optical system comprises reflected light limiting means for suppressing reflected light from a boundary surface between the bottom face of the container and the medium, the reflected light, out of the reflected lights, being substantially perpendicular to an optical axis of the observation optical system, the reflected light limiting means transmitting the remaining reflected lights.

2. The observation device according to claim 1, wherein the observation optical system further comprises illumination light control means for controlling the illumination lights, on a pupil surface of the observation optical system, and the reflected light limiting means is disposed on the pupil surface.

3. The observation device according to claim 1, wherein
the illumination light controlling means has an opening portion that transmits the center side of the illumination lights, and
the reflected light limiting means has an interrupting portion that interrupts the reflected lights, and
a size of at least one of the opening portion and the interruption portion is variable.

4. The observation device according to claim 1, further comprising imaging means for generating image data based on the remaining reflected lights that are not suppressed by the reflected light limiting means.

5. The observation device according to claim 2, wherein
the illumination light controlling means has an opening portion that transmits the center side of the illumination lights, and
the reflected light limiting means has an interrupting portion that interrupts the reflected lights, and
a size of at least one of the opening portion and the interruption portion is variable.

6. The observation device according to claim 2, further comprising imaging means for generating image data based on the remaining reflected lights that are not suppressed by the reflected light limiting means.

7. The observation device according to claim 3, further comprising imaging means for generating image data based on the remaining reflected lights that are not suppressed by the reflected light limiting means.

8. The observation device according to claim 2, wherein
the illumination light controlling means has an opening portion that transmits the center side of the illumination lights, and
the reflected light limiting means has an interrupting portion that interrupts the reflected lights, and
a size of at least one of the opening portion and the interruption portion is variable.
